(19) United States
(12) Patent Application Publication
(10) Pub. No.: US 2023/0296469 A1
(43) Pub. Date: Sep. 21, 2023

(54) METHOD AND DEVICE FOR DETECTING A LEAKAGE RATE OF A SOLID OXIDE FUEL CELL SYSTEM

(71) Applicant: Ceres Intellectual Property Company Limited, Horsham, West Sussex (GB)

(72) Inventors: Chuanxin Sun, Weifang, Shandong (CN); Lei Sun, Weifang, Shandong (CN); Xiaoguang Zheng, Weifang, Shandong (CN)

(21) Appl. No.: 17/928,686

(22) PCT Filed: Jun. 29, 2021
(86) PCT No.: PCT/CN2021/103081

§ 371 Date: Nov. 30, 2022

(30) Foreign Application Priority Data
Jun. 30, 2020 (CN) 202010624064.4

(51) Int. Cl. G01M 3/40; H01M 8/1231; H01M 8/04746; H01M 8/04537; H01M 8/0432; H01M 8/04992

(52) U.S. Cl. CPC G01M 3/40; H01M 8/1231; H01M 8/04753; H01M 8/04761; H01M 8/04544; H01M 8/0432; H01M 8/04992; H01M 2008/1293

(57) ABSTRACT

The invention discloses a method and device for detecting a leakage rate of a solid oxide fuel cell system on line. The method comprises steps of: cutting off fuel gas supply of an anode cavity, cutting off an exhaust line of the anode cavity and cutting off high-pressure air supply of a cathode cavity in the operation process of a solid oxide fuel cell; obtaining an open-circuit voltage and temperature of the solid oxide fuel cell; and determining a leakage rate of the solid oxide fuel cell system according to the open-circuit voltage and the temperature of the solid oxide fuel cell. Based on the technical solutions disclosed by the invention, the leakage rate of the solid oxide fuel cell system can be detected on line.

### TECHNICAL FIELD

The present application pertains to the technical field of fuel cell detection and relates to a method and device for detecting a leakage rate of a solid oxide fuel cell system on line, particularly to a method and device for detecting a leakage rate of a solid oxide fuel cell system for vehicles.

### BACKGROUND ART

A solid oxide fuel cell is a power generation device directly converting the chemical energy of the redox reactions of fuel gas and air into electric energy and is operated at high temperature. An anode cavity is arranged on an anode side of the solid oxide fuel cell and is used for accommodating fuel gas needed in the reactions. A cathode cavity is arranged on a cathode side of the solid oxide fuel cell and is used for accommodating air needed in the reactions. The solid oxide fuel cell, the anode cavity, and the cathode cavity constitute a solid oxide fuel cell system.

In the operation of a solid oxide fuel cell, if air leaks to the anode side, the material of the anode and the compact and porous structure of the anode may be affected, the performance of the solid oxide fuel cell may decline, and the life of the solid oxide fuel cell may suffer. Therefore, leakage detection of the solid oxide fuel cell system has always been a technical challenge and difficulty.

At present, the following method is used to detect the leakage rate of a solid oxide fuel cell system: an inert gas or air is input to the anode cavity and the cathode cavity of the solid oxide fuel cell system, and pressure changes are monitored to determine the leakage rate of the solid oxide fuel cell system. Based on this method, leakage rate detection is normally conducted before delivery of the solid oxide fuel cell system or before start of the solid oxide fuel cell system, and an additional cylinder must be carried.

### SUMMARY OF THE INVENTION

For this reason, an object of the present application is to provide a method and device for detecting a leakage rate of a solid oxide fuel cell system on line, which can detect the leakage rate of the solid oxide fuel cell system when the solid oxide fuel cell system is being operated.

According to one aspect of the present application, a method for detecting a leakage rate of a solid oxide fuel cell system on line is provided. The solid oxide fuel cell system comprises a solid oxide fuel cell, an anode cavity arranged on an anode side of the solid oxide fuel cell, and a cathode cavity arranged on a cathode side of the solid oxide fuel cell.

The method comprises steps of:
cutting off fuel gas supply of the anode cavity, cutting off an exhaust line of the anode cavity, and cutting off high-pressure air supply of the cathode cavity in the operation process of the solid oxide fuel cell;
obtaining an open-circuit voltage and temperature of the solid oxide fuel cell; and
determining a leakage rate of the solid oxide fuel cell system according to the open-circuit voltage and the temperature of the solid oxide fuel cell.

Optionally, the step of determining a leakage rate of the solid oxide fuel cell system according to the open-circuit voltage and the temperature of the solid oxide fuel cell comprises a step of:
calculating the leakage rate of the solid oxide fuel cell system according to

$$\frac{d {m}_{( Air )}}{dt} = \frac{{e}^{- \frac{dV}{a ⋆ dt}} - c}{b} ;$$

where,

$$\frac{d {m}_{( Air )}}{dt}$$

is the leakage rate of the solid oxide fuel cell system, V is the open-circuit voltage of the solid oxide fuel cell,

$$a = \frac{RT}{4 F} , b = \frac{0.21 RT}{{M}_{{O}_{2}} {V}_{a} {P}_{{O}_{2}}^{{C}_{1}}} , c = \frac{{P}_{{O}_{2}}^{{a}_{1}}}{{P}_{{O}_{2}}^{{C}_{1}}} ,$$

R is the molar gas constant, T is the temperature of the solid oxide fuel cell, F is the Faraday constant, Mₒ_{₂} is the molar mass of oxygen, Vₐ is the volume of the anode cavity, Pₒ_{₂}^{o}^{₂} is the oxygen partial pressure of the cathode cavity, Pₒ_{₂}^{a}^{₂} is the oxygen partial pressure of the anode cavity in a non-leaking state, and m_{(Air)} is the mass of leaking air.

Optionally, the step of determining a leakage rate of the solid oxide fuel cell system according to the open-circuit voltage and the temperature of the solid oxide fuel cell comprises steps of:
obtaining a pre-established correspondence between the open-circuit voltage and the temperature of the solid oxide fuel cell and the leakage rate; and
determining a leakage rate corresponding to the open-circuit voltage and the temperature of the solid oxide fuel cell according to the obtained correspondence between the open-circuit voltage and the temperature of the solid oxide fuel cell and the leakage rate.

Optionally, after the step of obtaining an open-circuit voltage and temperature of the solid oxide fuel cell, the method further comprises steps of:
implementing the step of determining a leakage rate of the solid oxide fuel cell system according to the open-circuit voltage and the temperature of the solid oxide fuel cell if the open-circuit voltage of the solid oxide fuel cell is greater than a preset voltage threshold; and
determining that a leakage occurs to the solid oxide fuel cell system if the open-circuit voltage of the solid oxide fuel cell is smaller than or equal to the preset voltage threshold.

Optionally, the method further comprises a step of:
outputting a prompt message if the open-circuit voltage of the solid oxide fuel cell is smaller than or equal to the preset voltage threshold.

According to another aspect of the present application, a device for detecting a leakage rate of a solid oxide fuel cell system on line is provided. The solid oxide fuel cell system comprises a solid oxide fuel cell, an anode cavity arranged on an anode side of the solid oxide fuel cell, and a cathode cavity arranged on a cathode side of the solid oxide fuel cell. The device comprises:
a temperature sensor, used for detecting the temperature of the solid oxide fuel cell;
a voltage sensor, used for detecting the open-circuit voltage of the solid oxide fuel cell; and
a controller connected to the temperature sensor and the voltage sensor, and used for: cutting off fuel gas supply of the anode cavity, cutting off an exhaust line of the anode cavity, and cutting off high-pressure air supply of the cathode cavity in the operation process of the solid oxide fuel cell; obtaining an open-circuit voltage and temperature of the solid oxide fuel cell; and determining a leakage rate of the solid oxide fuel cell system according to the open-circuit voltage and the temperature of the solid oxide fuel cell.

Optionally, the controller determines a leakage rate of the solid oxide fuel cell system according to the open-circuit voltage and the temperature of the solid oxide fuel cell.

The controller calculates the leakage rate of the solid oxide fuel cell system according to

$$\frac{{dm}_{( Air )}}{dt} = \frac{{e}^{- \frac{dV}{{a}^{*} dt}} - c}{b} ;$$

where,

$$\frac{{dm}_{( Air )}}{dt}$$

is the leakage rate of the solid oxide fuel cell system, V is the open-circuit voltage of the solid oxide fuel cell,

$$a = \frac{RT}{4 F} , b = \frac{0.21 RT}{\text{?}} , c = \frac{\text{?}}{\text{?}} ,$$

$$\text{?} \text{indicates text missing or illegible when filed}$$

R is the molar gas constant, is the temperature of the solid oxide fuel cell, F is the Faraday constant, Mₒ_{₂} is the molar mass of oxygen, Vₐ is the volume of the anode cavity, Pₒ_{₂}^{o}^{₂} is the oxygen partial pressure of the cathode cavity, Pₒ_{₂}^{a}^{₂} is the oxygen partial pressure of the anode cavity in a non-leaking state, and m_{(Air)} is the mass of leaking air.

Optionally, the controller determines a leakage rate of the solid oxide fuel cell system according to the open-circuit voltage and the temperature of the solid oxide fuel cell.

The controller obtains a pre-established correspondence between the open-circuit voltage and the temperature of the solid oxide fuel cell and the leakage rate, and determines a leakage rate corresponding to the open-circuit voltage and the temperature of the solid oxide fuel cell according to the obtained correspondence between the open-circuit voltage and the temperature of the solid oxide fuel cell and the leakage rate.

Optionally, a gas inlet of the anode cavity is connected to a fuel gas unit through a gas inlet line, an exhaust port of the anode cavity is connected to an exhaust line, and a solenoid valve is arranged on the exhaust line.

The controller cuts off fuel gas supply of the anode cavity and cuts off the exhaust line of the anode cavity The controller controls the fuel gas unit to stop outputting fuel gas and controls the solenoid valve to be cut off.

Optionally, a gas inlet of the anode cavity is connected to a fuel gas unit through a gas inlet line, an exhaust port of the anode cavity is connected to an exhaust line, a first solenoid valve is arranged on the gas inlet line, and a second solenoid valve is arranged on the exhaust line.

The controller cuts off fuel gas supply of the anode cavity and cuts off the exhaust line of the anode cavity, specifically, controls the first solenoid valve and the second solenoid valve to be cut off.

The present application discloses a method for detecting a leakage rate of a solid oxide fuel cell system on line. In the operation of the solid oxide fuel cell, fuel gas supply and an exhaust line of an anode cavity and high-pressure air supply of a cathode cavity are cut off, and in this state, a leakage rate of the solid oxide fuel cell system is determined according to the open-circuit voltage and the temperature of the solid oxide fuel cell. It can be seen that the method disclosed by the present application does not require inputting a gas into the anode cavity and the cathode cavity, and can determine the leakage rate of the solid oxide fuel cell system by determining the open-circuit voltage and the temperature of the solid oxide fuel cell under the condition of cutting off the fuel gas supply of the anode cavity, the exhaust line of the anode cavity, and the high-pressure air supply of the cathode cavity, so that the leakage rate is detected in the operation process of the solid oxide fuel cell system, i.e., the leakage rate of the solid oxide fuel cell system is detected on line, and the detection of the leakage rate of the solid oxide fuel cell system is not limited to before delivery and before start and has a broader application prospect. Further, the method disclosed by the present application does not need to use a cylinder, thereby reducing detection cost.

### BRIEF DESCRIPTION OF THE DRAWINGS

The drawings used in the description of the embodiments or the prior art will are briefly described below. These are just some embodiments of the present application.

FIG. 1 is a flow diagram of a method for detecting a leakage rate of a solid oxide fuel cell system on line.

FIG. 2 is a flow diagram of another method for detecting a leakage rate of a solid oxide fuel cell system on line.

FIG. 3 is a structural schematic view of a device for detecting a leakage rate of a solid oxide fuel cell system on line.

### DETAILED DESCRIPTION

Embodiments of the present application will he described below in conjunction with the drawings. The described embodiments are only some of the embodiments of the present application.

The present application provides a method and device for detecting a leakage rate of a solid oxide fuel cell system on line, which can detect the leakage rate of the solid oxide fuel cell system when the solid oxide fuel cell system is being operated.

The solid oxide fuel cell system comprises a solid oxide fuel cell comprising an anode cavity arranged on an anode side of the solid oxide fuel cell, and a cathode cavity arranged on a cathode side of the solid oxide fuel cell.

A gas inlet of the anode cavity is connected to a fuel gas unit through a gas inlet line. An exhaust port of the anode cavity is connected to an exhaust line. The exhaust line can be connected to a waste gas treatment device. The fuel gas output by the fuel gas unit enters the anode cavity and the fuel gas not participating in reactions and the reaction products are discharged from the exhaust port of the anode cavity. The gas inlet and the exhaust port of the cathode cavity are both communicated with the external environment. An air unit (e.g. a gas pressurizing device such as a blower) is also arranged at the gas inlet of the cathode cavity. When the air unit is open, pressurized air enters the cathode cavity. When the air unit is closed, normal-pressure air enters the cathode cavity. That is to say, no matter whether the air unit is open or not, the cathode cavity is in communication with the external environment.

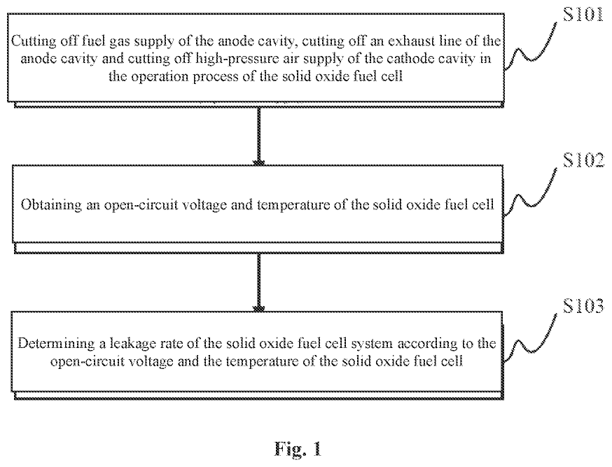

FIG. 1 is a flow diagram of a method for detecting a leakage rate of a solid oxide fuel cell system on line disclosed by the present application. The method comprises the following steps:
S101: cutting off fuel gas supply of the anode cavity, cutting off an exhaust line of the anode cavity and cutting off high-pressure air supply of the cathode cavity in the operation process of the solid oxide fuel cell.

Optionally, the following solution is adopted to cut off the fuel gas supply of the anode cavity and cut off the exhaust line of the anode cavity. A solenoid valve is arranged on the gas inlet line and the exhaust line of the anode cavity, respectively, and the two solenoid valves are controlled to be closed, thereby cutting off the fuel gas supply of the anode cavity and cutting off the exhaust line of the anode cavity.

Optionally, the following solution is adopted to cut off the fuel gas supply of the anode cavity and cut off the exhaust line of the anode cavity. A solenoid valve is arranged on the exhaust line of the anode cavity. The fuel gas unit is controlled to stop outputting fuel gas to the anode cavity and the solenoid valve is controlled to be closed, thereby cutting off the fuel gas supply of the anode cavity and cutting off the exhaust line of the anode cavity.

Cutting off high-pressure air supply of the cathode cavity means closing the air unit arranged at the gas inlet of the cathode cavity. In this case, the gas inlet and the exhaust port of the cathode cavity are still in communication with the external environment and the normal-pressure air can freely enter and leave the cathode cavity.

In the operation process of the solid oxide fuel cell system, the fuel gas supply of the anode cavity is cut off, the exhaust line of the anode cavity is cut off, and the high-pressure air supply of the cathode cavity is cut off, In this case, normal-pressure air can enter and leave the cathode cavity, while no fuel gas enters the anode cavity, and the reaction products and the fuel gas not participating in reactions cannot be discharged from the anode cavity.

S102: obtaining an open-circuit voltage and temperature of the solid oxide fuel cell.

The open-circuit voltage of the solid oxide fuel cell refers to the difference between the cathode electromotive force and the anode electromotive force of the solid oxide fuel cell.

The temperature of the solid oxide fuel cell can be the outlet temperature of the cathode cavity. A temperature sensor can be arranged at the outlet of the cathode cavity to detect the temperature of the solid oxide fuel cell.

S103: determining a leakage rate of the solid oxide fuel cell system according to the open-circuit voltage and the temperature of the solid oxide fuel cell.

In the operation process of the solid oxide fuel cell system, the open-circuit voltage of the solid oxide fuel cell in essence is a result of the combined action of the oxygen partial pressure on the cathode side and the oxygen partial pressure on the anode side. That is to say, the open-circuit voltage of the solid oxide fuel cell is correlated to the mass of the air leaking to the anode cavity. Further, the open-circuit voltage of the solid oxide fuel cell is also correlated to the temperature of the solid oxide fuel cell. Therefore, the leakage rate of the solid oxide fuel cell system can be determined according to the open-circuit voltage and the temperature of the solid oxide fuel cell.

The leakage rate of the solid oxide fuel cell system in the present application refers to an air leakage rate.

A method for detecting a leakage rate of a solid oxide fuel cell system on line is disclosed above. In the operation process of the solid oxide fuel cell, fuel gas supply of the anode cavity is cut off, an exhaust line of the anode cavity is cut off and high-pressure air supply of the cathode cavity is cut off, and in this state, a leakage rate of the solid oxide fuel cell system is determined according to the open-circuit voltage and the temperature of the solid oxide fuel cell. The method disclosed does not require inputting a gas into the anode cavity and the cathode cavity, and can determine the leakage rate of the solid oxide fuel cell system simply by determining the open-circuit voltage and the temperature of the solid oxide fuel cell under the condition of cutting off the fuel gas supply of the anode cavity, the exhaust line of the anode cavity, and the high-pressure air supply of the cathode cavity, so that the leakage rate is detected in the operation process of the solid oxide fuel cell system, i.e., the leakage rate of the solid oxide fuel cell system is detected on line, and the detection of the leakage rate of the solid oxide fuel cell system is not limited to before delivery and before start and has a broader application prospect. Further, the method disclosed by the present application does not need to use a cylinder, thereby reducing detection cost.

The method disclosed by the present application is implemented in the operation process of the solid oxide fuel cell system, but the fuel gas supply of the anode cavity, the exhaust line of the anode cavity, and the high-pressure air supply of the cathode cavity need to be cut off, so this solution can be implemented when the vehicle is in an idling state. For example, this method can be implemented when the vehicle is waiting at traffic lights, or in the period after the vehicle stops and is shut down.

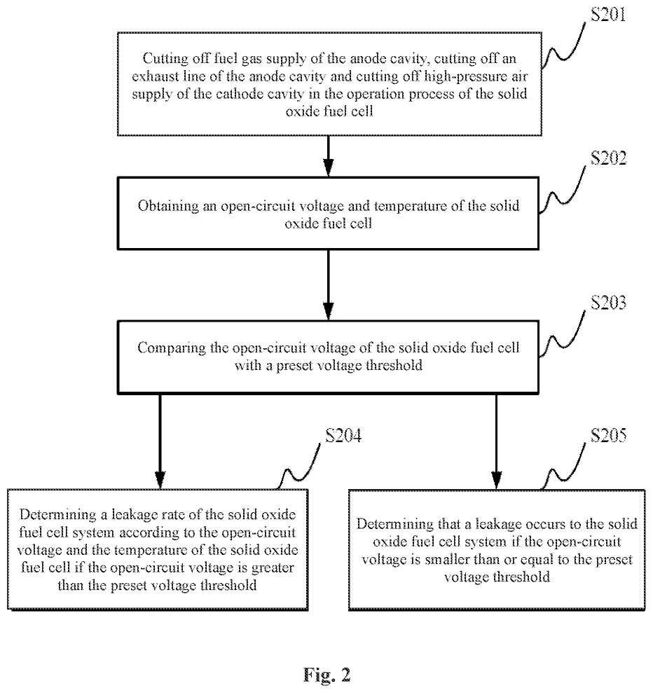

FIG. 2 is a flow diagram of another method for detecting a leakage rate of a solid oxide fuel cell system on line disclosed by the present application. The method comprises steps of:
S201: cutting off fuel gas supply of the anode cavity, cutting off an exhaust line of the anode cavity and cutting off high-pressure air supply of the cathode cavity in the operation process of the solid oxide fuel cell.
S202: obtaining an open-circuit voltage and temperature of the solid oxide fuel cell.
S203: comparing the open-circuit voltage of the solid oxide fuel cell with a preset voltage threshold, and implementing subsequent S204 or S205 according to the comparison result. If the open-circuit voltage of the solid oxide fuel cell is greater than the preset voltage threshold, then S204 is implemented, and if the open-circuit voltage of the solid oxide fuel cell is smaller than or equal to the preset voltage threshold, then S205 is implemented.
S204: determining a leakage rate of the solid oxide fuel cell system according to the open-circuit voltage and the temperature of the solid oxide fuel cell.
S205: determining that a leakage occurs to the solid oxide fuel cell system.

The open-circuit voltage of the solid oxide fuel cell is in negative correlation with the leakage rate of the solid oxide fuel cell system. That is to say, the greater the leakage rate of the solid oxide fuel cell system is, the smaller the open-circuit voltage of the solid oxide fuel cell will be. Therefore, when the open-circuit voltage of the solid oxide fuel cell is greater than the preset voltage threshold, a leakage rate of the solid oxide fuel cell system is determined according to the open-circuit voltage and the temperature of the solid oxide fuel cell. When the open-circuit voltage of the solid oxide fuel cell is smaller than or equal to the preset voltage threshold, a leakage to the solid oxide fuel cell can be determined, and in this case, it is not necessary to calculate the leakage rate of the solid oxide fuel cell system.

It should be noted that the preset voltage threshold is an empirical value. In implementation, the voltage threshold can be set to be 0, or a positive number approximate to 0.

The method for detecting a leakage rate of a solid oxide fuel cell system on line shown in FIG. 2 of the present application is compared with the method shown in FIG. 1. After the open-circuit voltage and the temperature of the solid oxide fuel cell are detected, the current open-circuit voltage is compared with a preset open-circuit voltage threshold. If the open-circuit voltage is greater than the preset voltage threshold, a leakage rate of the solid oxide fuel cell system is determined according to the open-circuit voltage and the temperature of the solid oxide fuel cell. If the open-circuit voltage is smaller than or equal to the preset voltage threshold, it is determined that a leakage occurs to the solid oxide fuel cell system, so that when a leakage occurs to the solid oxide fuel cell system, the occurrence can be determined even faster.

In an embodiment, on the basis of the method for detecting a leakage rate of a solid oxide fuel cell system on line shown in FIG. 2, the method further comprises a step of: outputting a prompt message if the open-circuit voltage is smaller than or equal to the preset voltage threshold.

That is to say, if the open-circuit voltage of the solid oxide fuel cell is smaller than or equal to the preset voltage threshold, it is determined that a leakage occurs to the solid oxide fuel cell system and a prompt message is output, thereby sending a prompt of a leakage to the user.

In the solid oxide fuel cell system, the open-circuit voltage of the solid oxide fuel cell is correlated to the mass of the air leaking to the anode cavity. Accordingly, the change rate of the open-circuit voltage of the solid oxide fuel cell is correlated to the leakage rate of the solid oxide fuel cell system.

In implementation, the leakage rate of the solid oxide fuel cell system can be determined according to the change rate of the open-circuit voltage of the solid oxide fuel cell.

In an embodiment, the following solution is adopted to determine a leakage rate of the solid oxide fuel cell system according to the open-circuit voltage and the temperature of the solid oxide fuel cell:
calculating the leakage rate of the solid oxide fuel cell system according to

$$\frac{{dm}_{( Air )}}{dt} = \frac{{e}^{- \frac{dV}{{a}^{*} dt}} - c}{b} .$$

where:

$$a = \frac{RT}{4 F} ;$$

$$b = \frac{0.21 RT}{\text{?}} ;$$

$$c = \frac{\text{?}}{\text{?}} ;$$

$$\frac{{dm}_{( Air )}}{dt}$$

$$\text{?} \text{indicates text missing or illegible when filed}$$

is the leakage rate of the solid oxide fuel cell system;
V is the open-circuit voltage of the solid oxide fuel cell;
R is the molar gas constant, and its value is 8.3145 J·mol⁻¹·K⁻¹;
T is the temperature of the solid oxide fuel cell, and may adopt thermodynamic temperature;
F is the Faraday constant, and its value is 9.6485×10⁴C:
Mₒ_{₂} is the molar mass of oxygen;
Vₐ is the volume of the anode cavity, specifically is the volume of the anode cavity in a closed state:
Pₒ_{₂}^{o}^{₂} is the oxygen partial pressure of the cathode cavity. The air entering the cathode cavity after the high-pressure air supply to the cathode cavity is cut off is normal-pressure air. Normally, the proportion of oxygen in the air is 21%, so the oxygen partial pressure of the cathode cavity is a constant;
Pₒ_{₂}^{a}^{₂} is the oxygen partial pressure of the anode cavity in a non-leaking state, and its value can be calibrated by means of experiments;
m_{(Air)} is the mass of leaking air.

In an embodiment, the following solution is adopted to determine a leakage rate of the solid oxide fuel cell system according to the open-circuit voltage and the temperature of the solid oxide fuel cell:
obtaining a pre-established correspondence between the open-circuit voltage and the temperature of the solid oxide fuel cell and the leakage rate; and
determining a leakage rate corresponding to the open-circuit voltage and the temperature of the solid oxide fuel cell according to the obtained correspondence between the open-circuit voltage and the temperature of the solid oxide fuel cell and the leakage rate.

That is to say, the correspondence between the open-circuit voltage and the temperature of the solid oxide fuel cell and the leakage rate is established in advance. In this correspondence, a group of values for the open-circuit voltage and the temperature of the solid oxide fuel cell correspond to a value for the leakage rate. After an open-circuit voltage and temperature of the solid oxide fuel cell are obtained, a value for the leakage rate corresponding to the open-circuit voltage and the temperature of the solid oxide fuel cell is looked up and obtained in the correspondence.

It should be noted that the process of establishing in advance the correspondence between the open-circuit voltage and the temperature of the solid oxide fuel cell and the leakage rate is based on

$$\frac{{dm}_{( Air )}}{dt} = \frac{{e}^{\frac{dV}{{a}^{*} dt}} - c}{b} .$$

A method for detecting a leakage rate of a solid oxide fuel cell system on line is disclosed above above. The present application further discloses a device for detecting a leakage rate of a solid oxide fuel cell system on line. The descriptions of the two herein can be mutually referred to.

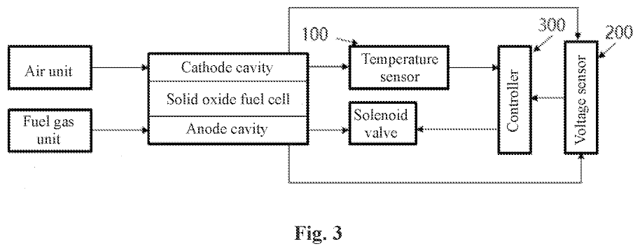

FIG. 3 is a structural schematic view of a device for detecting a leakage rate of a solid oxide fuel cell system on line. The device comprises a temperature sensor 100, a voltage sensor 200 and a controller 300.

The temperature sensor 100 is used for detecting the temperature of the solid oxide fuel cell.

In implementation, the temperature of the solid oxide fuel cell can be the outlet temperature of the cathode cavity. In implementation, the temperature sensor 100 can be arranged at the outlet of the cathode cavity to detect the outlet temperature of the cathode cavity, and set the outlet temperature of the cathode cavity as the temperature of the solid. oxide fuel cell.

The voltage sensor 200 is used for detecting the open-circuit voltage of the solid oxide fuel cell.

The controller 300 is connected to the temperature sensor 100 and the voltage sensor 200, and is used for: cutting off fuel gas supply of the anode cavity, cutting off an exhaust line of the anode cavity, and cutting off high-pressure air supply of the cathode cavity in the operation process of the solid oxide fuel cell; obtaining an open-circuit voltage and temperature of the solid oxide fuel cell; and determining a leakage rate of the solid oxide fuel cell system according to the open-circuit voltage and the temperature of the solid oxide fuel cell.

A device for detecting a leakage rate of a solid oxide fuel cell system on line is disclosed above. In the operation process of the solid oxide fuel cell, the controller cuts off fuel gas supply of the anode cavity, cuts off an exhaust line of the anode cavity, and cuts off high-pressure air supply of the cathode cavity, and in this state, the controller determines a leakage rate of the solid oxide fuel cell system according to the open-circuit voltage and the temperature of the solid oxide fuel cell. It can be seen that the device does not require inputting a gas into the anode cavity and the cathode cavity, and can determine the leakage rate of the solid oxide fuel cell system only by determining the open-circuit voltage and the temperature of the solid oxide fuel cell under the condition of cutting off the fuel gas supply of the anode cavity, the exhaust line of the anode cavity, and the high-pressure air supply of the cathode cavity, so that the leakage rate is detected in the operation process of the solid oxide fuel cell system, i.e., the leakage rate of the solid oxide fuel cell system is detected on line, and the detection of the leakage rate of the solid oxide fuel cell system is not limited to before delivery and before start and has a broader application prospect. Further, the device does not need to use a cylinder, thereby reducing detection cost.

In an embodiment, the controller 300 is further used for: comparing the obtained open-circuit voltage of the solid oxide fuel cell with a preset voltage threshold, determining a leakage rate of the solid oxide fuel cell system according to the open-circuit voltage and the temperature of the solid oxide fuel cell if the open-circuit voltage of the solid oxide fuel cell is greater than the preset voltage threshold, and determining a serious leakage of the solid oxide fuel cell system if the open-circuit voltage of the solid oxide fuel cell is smaller than or equal to the preset voltage threshold.

Optionally, the controller 300 is further used for: outputting a prompt message if the open-circuit voltage of the solid oxide fuel cell is smaller than or equal to the preset voltage threshold.

In an embodiment, the controller 300 determines a leakage rate of the solid oxide fuel cell system according to the open-circuit voltage and the temperature of the solid oxide fuel cell:

The controller 300 calculates the leakage rate of the solid oxide fuel cell system according to

$$\frac{{dm}_{( Air )}}{dt} = \frac{{e}^{- \frac{dV}{{a}^{*} dt}} - c}{b} ;$$

where,

$$\frac{{dm}_{( Air )}}{dt}$$

is the leakage rate of the solid oxide fuel cell system, V is the open-circuit voltage of the solid oxide fuel cell,

$$a = \frac{RT}{4 F} , b = \frac{0.21 RT}{\text{?}} , c = \frac{\text{?}}{\text{?}} ,$$

$$\text{?} \text{indicates text missing or illegible when filed}$$

R is the molar gas constant, T is the temperature of the solid oxide fuel cell, F is the Faraday constant, Mₒ_{₂} is the molar mass of oxygen, Vₐ is the volume of the anode cavity, Pₒ_{₂}^{o}^{₂} is the oxygen partial pressure of the cathode cavity, is the oxygen partial pressure of the anode cavity in a non-leaking state, and Pₒ_{₂}^{a}^{₂} is the mass of leaking air.

In an embodiment, the controller 300 determines a leakage rate of the solid oxide fuel cell system according to the open-circuit voltage and m_{(Air)} the temperature of the solid oxide fuel cell:

The controller 300 obtains a pre-established correspondence between the open-circuit voltage and the temperature of the solid oxide fuel cell and the leakage rate, and determines a leakage rate corresponding to the open-circuit voltage and the temperature of the solid oxide fuel cell according to the obtained correspondence between the open-circuit voltage and the temperature of the solid oxide fuel cell and the leakage rate.

In an embodiment, a gas inlet of the anode cavity of the solid oxide fuel cell system is connected to a fuel gas unit through a gas inlet line, an exhaust port of the anode cavity is connected to an exhaust line, and a solenoid valve is arranged on the exhaust line, as shown in FIG. 3. The controller 300 cuts off fuel gas supply of the anode cavity and cuts off an exhaust line of the anode cavity. The controller 300 controls the fuel gas unit to stop outputting fuel gas and controls the solenoid valve to be cut off.

In an embodiment, a gas inlet of the anode cavity of the solid oxide fuel cell system is connected to a fuel gas unit through a gas inlet line, an exhaust port of the anode cavity is connected to an exhaust line, and a solenoid valve is arranged on the gas inlet line and the exhaust line, respectively. The solenoid valve arranged on the gas inlet line is called a first solenoid valve, and the solenoid valve arranged on the exhaust line is called a second solenoid valve. The controller 300 cuts off the fuel gas supply of the anode cavity and cuts off the exhaust line of the anode cavity, specifically, the controller 300 controls the first solenoid valve and the second solenoid valve to be closed.

The relational terms herein such as first and second are only used to distinguish one entity or operation from another entity or operation and do not necessarily require or imply any such actual relation or sequence among these entities or operations. Furthermore, the terms “comprise,” “include” and any other equivalent expressions are intended to cover non-exclusive inclusion so that a process, method, object or device comprising a series of factors not only includes these factors but also includes other factors not expressly listed, or also includes factors inherent with the process, method, object or device. Under the condition of no further limitations, the factors delimited by the expression “comprise a . . . ” do not exclude other same factors in the process, method, object or device including said. factors.

The embodiments in the description are all described in a progressive manner, each embodiment focuses on the differences from other embodiments, and the same or similar parts among the embodiments can be mutually referred to. The device disclosed in an embodiment corresponds to the method disclosed in an embodiment, so the device is simply described and for the relevant parts, please refer to the description in the method embodiments.

Various modifications to these embodiments will be apparent. The general principle defined herein can be implemented in other embodiments without departing from the scope of the claims.

1. A method for detecting a leakage rate of a solid oxide fuel cell system on line, wherein the solid oxide fuel cell system comprises a solid oxide fuel cell, an anode cavity arranged on an anode side of the solid oxide fuel cell, and a cathode cavity arranged on a cathode side of the solid oxide fuel cell, wherein the method comprises:
ceasing fuel gas supply to the anode cavity, closing an exhaust line of the anode cavity, and ceasing high-pressure air supply to the cathode cavity in the operation process of the solid oxide fuel cell;
obtaining an open-circuit voltage and temperature of the solid oxide fuel cell; and
determining a leakage rate of the solid oxide fuel cell system according to the open-circuit voltage and the temperature of the solid oxide fuel cell.

2. The method according to claim 1, wherein determining a leakage rate of the solid oxide fuel cell system according to the open-circuit voltage and the temperature of the solid oxide fuel cell comprises:
calculating the leakage rate of the solid oxide fuel cell system according to
$$\frac{{dm}_{( Air )}}{dt} = \frac{{e}^{- \frac{dV}{{a}^{*} dt}} - c}{b} ;$$
where
$$\frac{{dm}_{( Air )}}{dt}$$
is the leakage rate of the solid oxide fuel cell system,
V is the open-circuit voltage of the solid oxide fuel cell,
$$a = \frac{RT}{4 F} , b = \frac{0.21 RT}{\text{?}} , c = \frac{\text{?}}{\text{?}} ,$$
$$\text{?} \text{indicates text missing or illegible when filed}$$
R is the molar gas constant,
T is the temperature of the solid oxide fuel cell,
F is the Faraday constant,
Mₒ_{₂} is the molar mass of oxygen,
Vₐ is the volume of the anode cavity,
Pₒ_{₂}^{o}^{₂} is the oxygen partial pressure of the cathode cavity,
Pₒ_{₂}^{a}^{₂} is the oxygen partial pressure of the anode cavity in a non-leaking state, and
m_{(Air)} is the mass of leaking air.

3. The method according to claim 1, wherein determining a leakage rate of the solid oxide fuel cell system according to the open-circuit voltage and the temperature of the solid oxide fuel cell comprises:
obtaining a pre-established correspondence between the open-circuit voltage and the temperature of the solid oxide fuel cell and the leakage rate; and
determining a leakage rate corresponding to the open-circuit voltage and the temperature of the solid oxide fuel cell according to the obtained correspondence between the open-circuit voltage and the temperature of the solid oxide fuel cell and the leakage rate.

4. The method according to claim 1, wherein after obtaining an open-circuit voltage and temperature of the solid oxide fuel cell, the method further comprises:
when the open-circuit voltage of the solid oxide fuel cell is greater than a preset voltage threshold, implementing the step of determining a leakage rate of the solid oxide fuel cell system according to the open-circuit voltage and the temperature of the solid oxide fuel cell; or
when the open-circuit voltage of the solid oxide fuel cell is less than or equal to the preset voltage threshold, determining that a leakage occurs to the solid oxide fuel cell system.

5. The method according to claim 4, further comprising:
outputting a prompt message if the open-circuit voltage of the solid oxide fuel cell is less than or equal to the preset voltage threshold.

6. A device for detecting a leakage rate of a solid oxide fuel cell system on line, the solid oxide fuel cell system comprising a solid oxide fuel cell, an anode cavity arranged on an anode side of the solid oxide fuel cell, and a cathode cavity arranged on a cathode side of the solid oxide fuel cell, wherein the device comprises:
a temperature sensor for detecting the temperature of the solid oxide fuel cell;
a voltage sensor for detecting the open-circuit voltage of the solid oxide fuel cell; and
a controller connected to the temperature sensor and the voltage sensor;
wherein the controller is operable to: cease fuel gas supply to the anode cavity, close an exhaust line of the anode cavity, and cease high-pressure air supply of the cathode cavity in the operation process of the solid oxide fuel cell; obtain an open-circuit voltage and temperature of the solid oxide fuel cell; and determine a leakage rate of the solid oxide fuel cell system according to the open-circuit voltage and the temperature of the solid oxide fuel cell.

7. The device according to claim 6, wherein the controller is operable to determine a leakage rate of the solid oxide fuel cell system according to the open-circuit voltage and the temperature of the solid oxide fuel cell, wherein the controller is configured to calculate the leakage rate of the solid oxide fuel cell system according to
$$\frac{{dm}_{( Air )}}{dt} = \frac{{e}^{- \frac{dV}{{a}^{*} dt}} - c}{b} ;$$
where,
$$\frac{{dm}_{( Air )}}{dt}$$
is the leakage rate of the solid oxide fuel cell system,
V is the open-circuit voltage of the solid oxide fuel cell,
$$a = \frac{RT}{4 F} ,$$
$$b = \frac{0.21 RT}{\text{?}} ,$$
$$c = \frac{\text{?}}{\text{?}} ,$$
$$\text{?} \text{indicates text missing or illegible when filed}$$
R is the molar gas constant,
T is the temperature of the solid oxide fuel cell,
F is the Faraday constant,
Mₒ_{₂} is the molar mass of oxygen,
Vₐ is the volume of the anode cavity,
Pₒ_{₂}^{o}^{₂} is the oxygen partial pressure of the cathode cavity,
Pₒ_{₂}^{a}^{₂} is the oxygen partial pressure of the anode cavity in a non-leaking state, and
M_{(Air)} is the mass of leaking air.

8. The device according to claim 6, wherein the controller is operable to determine a leakage rate of the solid oxide fuel cell system according to the open-circuit voltage and the temperature of the solid oxide fuel cell, wherein the controller is configured to obtain a pre-established correspondence between the open-circuit voltage and the temperature of the solid oxide fuel cell and the leakage rate, and determine a leakage rate corresponding to the open-circuit voltage and the temperature of the solid oxide fuel cell according to the obtained correspondence between the open-circuit voltage and the temperature of the solid oxide fuel cell and the leakage rate.

9. The device according to claim 6, wherein a gas inlet of the anode cavity is connected to a fuel gas unit through a gas inlet line, an exhaust port of the anode cavity is connected to an exhaust line, and a solenoid valve is arranged on the exhaust line; and
wherein the controller is operable to cease fuel gas supply of the anode cavity and close the exhaust line of the anode cavity, and control the fuel gas unit to stop outputting fuel gas, and close the solenoid valve.

10. The device according to claim 6, wherein a gas inlet of the anode cavity is connected to a fuel gas unit through a gas inlet line, an exhaust port of the anode cavity is connected to an exhaust line, a first solenoid valve is arranged on the gas inlet line, and a second solenoid valve is arranged on the exhaust line; and
wherein the controller is operable to cease fuel gas supply to the anode cavity and close the exhaust line of the anode cavity, and control the first solenoid valve and the second solenoid valve to be closed.
